(19) United States
(12) Patent Application Publication
(10) Pub. No.: US 2005/0133330 A1
(43) Pub. Date: Jun. 23, 2005

(54) Slip clutch with different slip points for forward and reverse

(75) Inventor: Thomas L. Stiefvater, Ephrata, PA (US)

Correspondence Address: Martin Fruitman;New Holland North America, Inc., Intellectual Property Dept., P.O. Box 1895, MS 641, New Holland, PA, 17557, US

(73) Assignee: New Holland North America, Inc., New Holland, PA (US)

(21) Appl. No.: 10/738,517

(22) Filed: Dec. 17, 2003

(51) Int. Cl. F16D 7/00

(52) U.S. Cl. 192/55.1; 192/69.81

(57) ABSTRACT

The apparatus is a slip clutch with matching and interlocking peaks and valleys on its two engageable surfaces and sloping sides on the peaks and valleys so that the surfaces slip on the sloping sides when the force between the surfaces exceeds the force of a spring holding the surfaces together. The slopes of the opposite sides of the peak and valleys are different so that the slip point of the clutch is different depending upon the direction of motion of the clutch.

### BACKGROUND OF THE INVENTION

This invention deals generally with slip clutches and more specifically with a slip clutch that has higher slip torque in one direction than it has in the opposite direction.

Slip clutches are relatively common devices in many applications. They serve to protect motors, transmissions, and other power transfer equipment from harmful overloads. Perhaps the most common slip clutch is one in which there is an inherent limit of the coefficient of friction between two rotating disc surfaces that are in contact with each other. In such an arrangement, when the driven surface of the clutch is stopped for any reason, the driving surface continues rotating and the two contacting surfaces simply slip on each other because the torque between them overcomes the friction between their surfaces. The principle is so basic that at some time we all have experienced a similar phenomenon when we wet our fingers to turn a page of a book. This increases the coefficient of friction between the finger and the page to overcome the “load” of turning the page because otherwise the dry finger, like a slip clutch, would slip on the page, the opposing surface.

Common slip clutches have the same slip torque point regardless of the direction of motion of the clutch. This makes perfect sense, because the associated drive train usually has the same damage point in both forward and reverse. However, there are times when it would be beneficial to have a higher slip point torque in the reverse direction than in the forward direction. To use another very mundane example, who among us would not want a higher slip torque in reverse for our vehicle tires on ice if we have nosed into a snow bank on an icy road. Better traction between the tires and the road in reverse would make it easy to simply back away from the snow bank.

However, there are also some real situations in which a higher slip torque point in reverse for a slip clutch would be very beneficial. It would be a particular advantage for many applications using farm machinery. One particular application is in a mower conditioner. In such a machine, the crop is first cut and then conditioned by feeding it into counter rotating rollers. However, if a “slug”, a thick batch of crop, is picked up and fed into the conditioner, the rollers can jam, and that is when the slip clutch operates and protects the drive system from damage. The problem that is likely to occur with a standard slip clutch is that the clutch will also slip when there is an attempt to run the rollers in reverse to clear the jam. Such a situation then requires shutting down the machine and manually clearing the jammed rollers.

Actually the same problem can occur in virtually any machine that has a roller processing some material. Any unusually thick material can jam the roller and require manual cleaning.

It would be very beneficial to have a slip clutch with a sufficiently higher slip torque in reverse to permit operating the entire system in reverse after it has jammed during forward operation. This would mean that clearing jams would only require running the machine in reverse for a short time.

### SUMMARY OF THE INVENTION

The present invention is a slip clutch that has a different slip torque in each of its two directions of rotation. The apparatus of the present invention is a simple modification of a type of slip clutch conventionally available. This type of conventional jaw slip clutch has two jaws with facing rotating surfaces that include tooth like matching and interlocking peaks and valleys, with one surface of the clutch held against the other surface by a compression spring. To accomplish the slip action, the matching and interlocking peak and valleys have sloping sides so that when the applied torque exceeds a preselected torque needed to overcome the spring force, the slopes of one clutch jaw slide along the slopes of the other clutch jaw and the two clutch jaws disengage. Such clutches are generally available, and because all the slopes on both sides of the peak and valleys are the same, the slip torque is the same in both directions of rotation.

The present invention furnishes a slip clutch with different slip torques in the forward and reverse directions by simply using different angles on the opposite sloping sides of the peak and valleys of both facing jaw surfaces. Thus, the conventional clutch design is modified to have a shallower slope angle on the surfaces of the peak and valleys that transfer force in the forward direction than the slope on the surfaces that transfer force in the reverse direction. That results in the clutch slipping at a lower torque in the forward direction than the torque required for it to slip in the reverse direction.

This simple change in the shape of only two of the many parts in a clutch assembly, yields the very desirable result of allowing any apparatus protected by a slip clutch to be cleared of a blockage by merely reversing the motion of the apparatus. The steeper slope on the slip clutch contact surfaces in the reverse direction will allow the clutch to remain engaged even if more torque is required in reverse to clear the jam than was needed in the forward direction to create the blockage.

### BRIEF DESCRIPTION OF THE DRAWINGS

FIG.1 is an exploded perspective view of a typical prior art jaw slip clutch assembly.

FIG. 2 is a schematic view of the peak and valley structure of the prior art jaw slip clutch.

FIG. 3 is a schematic view of the peak and valley structure of the preferred embodiment of the invention with an attached diagram of the applied forces.

### DETAILED DESCRIPTION OF THE INVENTION

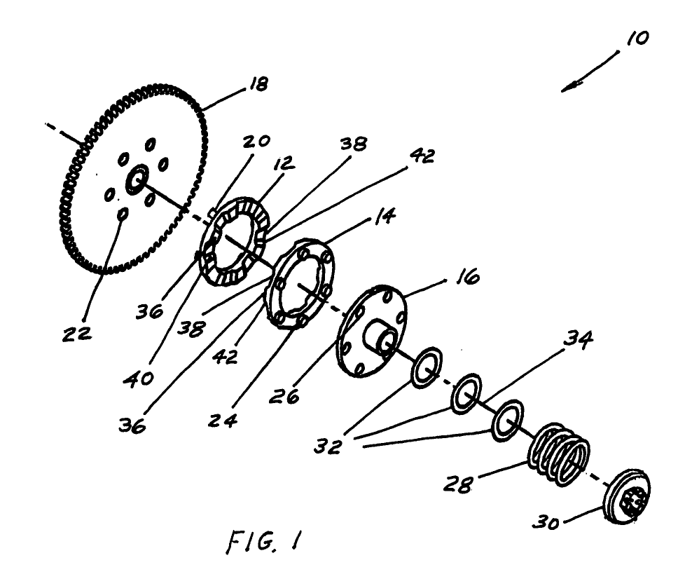

FIG. 1 is an exploded perspective view of a typical jaw slip clutch assembly 10 of the prior art. The most pertinent parts of the assembly for the purpose of the present invention are clutch jaws 12 and 14, which interlock to transfer power from drive plate 16 to driven gear 18. Driven clutch jaw 12 has rear pins 20 that lock into holes 22 on driven gear 18, and drive clutch jaw 14 has similar rear pins 24 that lock into holes 26 on drive plate 16. The other active parts of slip clutch assembly 10 are compression spring 28 and spring locking assembly 30. Drive plate 16, compression spring 28, and spring locking assembly 30, along with washers 32 are mounted on a drive shaft (not shown) that is on a common axis of rotation 34 for all the clutch parts and extends from drive plate 16 to spring locking assembly 30 and beyond where it is interconnected to a driving member such as a motor (not shown).

The operating function of slip clutch assembly 10 is performed by peaks 36 and valleys 38 of clutch jaw 12 that fit into the identical peaks and valleys of clutch jaw 14 as clutch jaw 14 is held against clutch jaw 12 by compression spring 28, thus transferring power from drive plate 16 to driven gear 18. However, sloping sides 40 and 42 on peaks 36 and valleys 38 provide the required slip function of slip clutch assembly 10. The two clutch jaws slip relative to each other when the torque between clutch jaw 16 and clutch jaw 14 causes the clutch jaws to separate. The clutch jaws separate when the axial force component of the force perpendicular to the clutch jaw sloping sides 40 exceeds the force applied by spring 28. Separation of the clutch jaws causes the clutch to slip in a ratcheting manner.

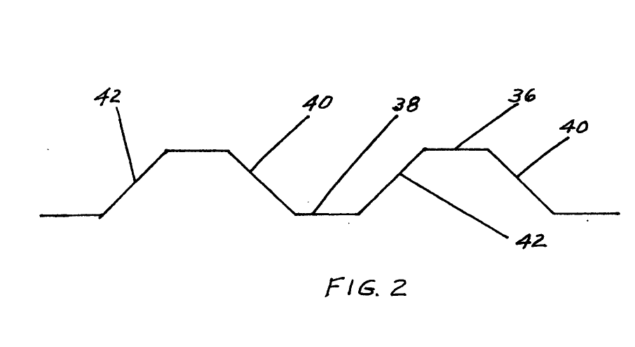

Prior art slip clutch assemblies of the type shown in FIG. 1 have always been constructed with symmetrical peaks and valleys as shown in FIG. 2. That is, the slopes on both sides of the peaks and valleys have always had complimentary angles. This has been desirable in the standard slip clutch because the associated drive train usually has the same damage point in both forward and reverse, and therefore the slip clutch required the same slip torque point in both directions of rotation.

FIG. 2 is a schematic view of the peak and valley structure of such a prior art jaw slip clutch, and for clarity FIG. 2 is drawn with no curvature. It should be appreciated that the peak and valley structure of FIG. 2 is appropriate for both driven jaw clutch 12 and drive jaw clutch 14, particularly when the jaws are interlocked. FIG. 2 shows peaks 36 interconnected to valleys 38 by sides 40 and 42 that have slopes with complimentary angles. As a typical example these angles are shown as 45 degrees for sides 40 and 135 degrees for sides 42.

However, for applications where a higher reverse slip torque point is desirable to permit reversing the drive unit to counteract a jam in the forward direction, the angles of the two sloping sides of each peak are different. The present invention accomplishes just such a function. The jaw clutch slip clutch of the preferred embodiment of the invention is actually constructed in essentially the same manner as shown in FIG. 1 except that the shapes of peaks 36 and valleys 38 are different from the shapes shown in FIG. 2.

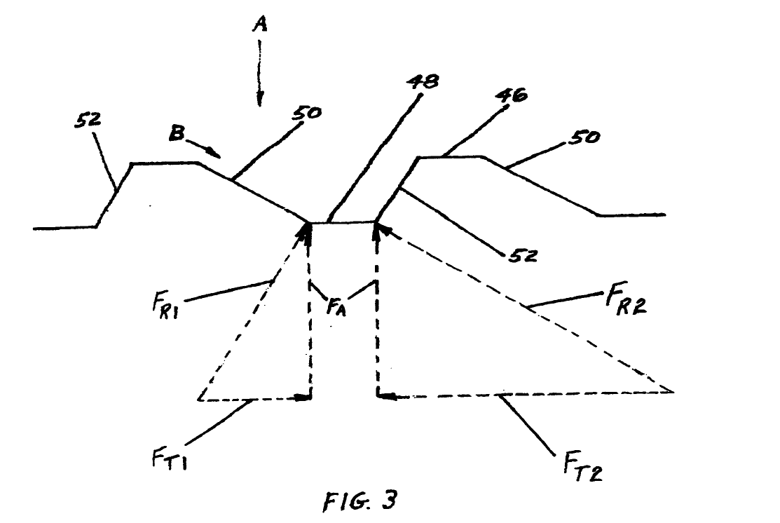

FIG. 3 is a schematic view of the peak and valley structure of the preferred embodiment of the invention in which peaks 46 and valleys 48 are the same size as those shown in FIG. 2, but slopes 50 and 52 between the peaks and valleys are not complimentary angles. In the preferred embodiment shown in FIG. 3 sloping sides 52 are 60 degrees and sloping sides 50 are 150 degrees.

With such a configuration, The slip torque point is different for the two directions of rotation of the clutch. The direction of rotation of the clutch determines whether the force between the clutch jaws is being transferred on slopes 52 or slopes 50. Because of the difference in the angle of the slopes, the torque required to cause slippage on surface 52 is substantially greater than the torque required to cause slippage on the shallower slope of surface 50.

The difference between the slip torque provided by slope 50 and slope 52 is evident from the diagram in FIG. 3 of the forces acting on the clutch slopes. These forces are shown with dashed lines. The transmitted clutch torque causes tangential forces F_{T1} and F_{T2} as shown, and compression spring 28 exerts an axial force F_{A} as shown that is perpendicular to the tangential forces. The result of tangential forces F_{T1} and F_{T2} and axial force F_{A} are resultant forces F_{R1} and F_{R2}, which act perpendicularly to clutch slopes 50 or 52, depending upon the direction of the applied force. The force diagrams show that, for the same spring force F_{A,} the resultant perpendicular force F_{R2} on ramp 52 exceeds perpendicular force F_{R1} on ramp 50. Also, for the same spring force F_{A} tangential force F_{T2} and the resulting clutch torque on ramp 52 are considerably greater than tangential force F_{T1} and the resulting clutch torque on ramp 50.

Because the structure described in FIG. 3 provides a higher torque slip point in one direction than in the other, the present invention furnishes a slip clutch that can be used to back off any device from a condition in which forward motion has caused the mechanism to jam and the clutch to slip.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims. For example, the differing slopes of the sides of the peaks and valleys may have angles other than those specified for the preferred embodiment, and the driven member is not restricted to a gear. Furthermore, the clutch itself need not be constructed as rotating facing surfaces, but can have another geometry.

1. In a slip clutch having two engagable and separable surfaces held against each other by the force of a spring, with the surfaces having matching and interlocking peaks and valleys with angular sloping sides so that, at a preselected slip torque between the surfaces, the sloping sides of the peaks and valleys on the two surfaces slip on each other and disengage the surfaces, the improvement comprising:
different angles on the opposite sloping sides of the peaks and valleys so that the preselected slip torque is different depending on the direction of movement of the surfaces.

2. The slip clutch of claim 1 wherein the two surfaces rotate with a common axis of rotation.

3. The slip clutch of claim 1 wherein the two surfaces rotate with a common axis of rotation and the spring is a compression spring centered on the common axis of rotation.

4. A slip clutch comprising:
two engagable and separable surfaces held against each other by the force of a spring;
the surfaces having matching and interlocking peaks and valleys with angular sloping sides so that, at a preselected slip torque between the surfaces, the sloping sides of the peaks and valleys on the two surfaces slip on each other and disengage the surfaces; and
different angles on the opposite sloping sides of the peaks and valleys so that the preselected slip torque is different depending on the direction of movement of the surfaces.

5. The slip clutch of claim 4 wherein the two surfaces rotate with a common axis of rotation.

6. The slip clutch of claim 4 wherein the two surfaces rotate with a common axis of rotation and the spring is a compression spring centered on the common axis of rotation.
